(19) United States
(12) Patent Application Publication
(10) Pub. No.: US 2023/0223601 A1
(43) Pub. Date: Jul. 13, 2023

(54) AN ELECTRODE AND A METHOD OF PROVIDING AN ELECTRODE AND A BATTERY LAMINATE

(71) Applicant: LEAPAGRO APS, Copenhagen K (DK)

(72) Inventors: Jens Wagonblast Stubbe OSTERGAARD, Roskilde (DK); Johannes Anders SMITH, Copenhagen K (DK)

(21) Appl. No.: 18/010,650

(22) PCT Filed: Jun. 22, 2021
(86) PCT No.: PCT/EP2021/067048

§ 371 Date: Dec. 15, 2022

(30) Foreign Application Priority Data
Jun. 22, 2020 (DK) PA 2020 70407

(51) Int. Cl. H01M 10/0583; H01M 4/80

(52) U.S. Cl. CPC H01M 10/0583; H01M 4/80; H01M 2004/021

(57) ABSTRACT

An electrode, a battery laminate, a battery and methods of providing the electrode, laminate or battery, where the electrode has an electrode layer and a current collector both having through-going bores of a size allowing liquid transport through the current collector and the electrode layer. The bores are provided by providing elongate slits or weakened portions and deforming the electrode. The current collector also has channels therein allowing liquid to travel along a plane of the current collector. In this manner, the drying of and introduction of electrolyte therein is made much faster.

Folding of laminates and other battery improving technologies may be seen in Applicant's co-pending applications PCT/EP2020/064868 an PCT/EP2020/064866 which are hereby incorporated by reference.

The present invention relates to an electrode and a method of providing an electrode and a battery laminate and in particular to an electrode and laminate which has superior properties when rolled and dried or added a liquid.

Battery production usually comprises adding slurries and/or fluids to form a laminate and then drying the laminate. Drying the laminate while not rolled takes up a lot of space and makes rolling of the laminate difficult. Drying the laminate while rolled takes a long time and thus also requires a lot of space. Similarly, the final, dried laminate often is desired added a fluid, often called an electrolyte, which is desired inside the laminate. Thus, it is desired to provide an electrode structure which facilitates fast transport of the electrolyte into the laminate, preferably also when the laminate is rolled into a roll or folded to become a pouch battery for example.

Relevant battery technology may be seen in US2020/0144676.

A first aspect of the invention relates to an electrode, such as for a battery, the electrode comprising:

a current collector having a first and a second main surfaces, and
a first layer of a first electrically conductive material provided at or on the first main surface, and
where the current collector comprises a plurality of slits, having a length of at least 2 μm, the laminate being deformed to provide the slits with a width of at least 2 μm.

By providing the slits, both the current collector and the first layer each has a first plurality of through-going bores each having a cross sectional area of at least 2 μm.

In addition, the current collector may then comprise, between the first and second main surfaces, a plurality of channels extending at least substantially in a plane of the current collector, each channel having a mean cross section with a shortest distance of at least 2 μm.

In this context, the electrode is an element capable of receiving and holding a charge, such as is desired in a battery usually having two electrodes called the anode and the cathode.

In this context a bore may be a cylindrical hole made by or as if by the turning or twisting movement of a tool but we define bore or bores more widely as formed openings and an opening is usually defined a hole or space that something can pass through. The bore may be generated in a material or surface, or the material or surface may be generated comprising the bore from the start.

The present electrode has two main portions being an electrode material capable of holding the charge and a current collector with the main function of feeding charge to or removing charge from the electrode material. Often, the current collector will extend out of the electrode material so as to be contactable from outside of the electrode.

The electrode material is an electrically conducting material. A number of materials, usually metals, are known as electrode materials in batteries.

The electrode layers in batteries often form an anode layer and a cathode layer which are configured to cooperate and have an ion interchange facilitating the current out of or into the battery. A battery often also has a separator with the function of allowing the ion transport but preventing direct, electrical contact between the anode layer and the cathode layer. Separators may be made of polymers, Kevlar, ceramics or the like.

The current collector has a first and a second, usually opposite, main surfaces. The main surfaces comprise at least openings for the through-going bores. A main surface may be defined as a surface defined by portions of the current collector extending the farthest from a general or central plane of the current collector or from surfaces defining the other main surface. The current collector often is oblong and has a longitudinal direction. Often the current collector is rectangular, so that the longitudinal direction is along the longest side thereof. Then, the main surfaces may be surfaces parallel with the rectangular shape of the current collector.

The electrode may be plane, is often manufactured as a plane laminate, but is often then folded or rolled to become more compact and fit better into different applications, such as batteries for different purposes.

Then, the general or central plane may be a plane parallel to the main surfaces, such as a plane directly between the two main surfaces.

The main surfaces may, thus, be straight, as is often the situation during production, or bent, which is often the situation in use situations in batteries. Usually, however, the main surfaces will be parallel at least piecewise, as is the case with the outer surfaces of layers even in rolled laminates.

The current collector may be made of an electrically conducting material or may comprise an electrically conducting material, such as on or at the main surface thereof. The electrically conducting material may as described above, take part in a transport of charge to or from the electrode material.

A first layer of a first electrode material is provided at or on the first main surface. Preferably, this material is electrically conducting or comprises an electrically conducting or charge holding material.

In this context, an electrically conducting material is a material with an electrical resistivity of at no more than 100,000, such as no more than 10,000, such as no more than 500 μΩcm at 273K. Usual conducting materials are metals, such as aluminium, copper, tin, antimony, nickel, silicon, or magnesium. However, also semiconducting materials such as Silicon may be used. It is preferred that the material has a rather low melting point and is malleable and is functional in the electrode as an anode or cathode material.

The current collector and laminate is deformed. Deformation means that the laminate is brought away from its former, often plane, shape. Deformation may mean that an outer contour, in some cross-section, is altered. The slits need not be through-going or open in the not-stretched configuration.

The deformed current collector comprises a plurality of through-going slits or bores each having a length of at least 2 μm. A slit or bore is through-going when it extends from one outer surface to another outer surface. The bore may extend directly across the material or may be meandering inside the material. The bores may be more or less interconnected so that a mesh of bores exist in the current collector. In that situation, liquid may be transported in different directions in the current collector, which is preferred.

Preferably, a large number of slits or bores exist in the deformed current collector. The slits or bores have openings at the outer surface so that liquid may enter or travel around the current collector material.

A bore or slit has a cross section with a shortest width or distance of 2 μm. The cross section of a bore may alter over an extent of the bore. The cross section of the bore may be determined at each position of the extent of the bore from one opening to another opening of the bore. A bore may extend partially into the current collector where it divides into multiple bores, ends in another bore or intersects with other bores. Liquid entering the bore thus may travel from one opening to the other via one of a number of possible bores.

In order to transport liquid, the bore or slit has a minimum dimension of 2 μm. This minimum may be the minimum dimension in the cross section at any position along the extent of the bore. The cross section often is that in a plane perpendicular to the extent of the bore, such as perpendicular to a main direction of liquid flowing at that position in the bore. In the cross section, the bore will define, usually, a closed curve, where the minimum dimension is the smallest distance from one portion of the curve to an opposite position of the curve, such as through a centre of the curve or between portions of the curve with the same direction or having parallel tangents.

Clearly, the other dimensions of the cross-sectional shape may be larger.

Also, the minimum distance/width/length may be at least 3 μm, such as at least 4 μm, such as at least 5 μm, such as at least 6 μm, such as at least 8 μm, such as at least 10 μm. Distances/widths/lengths may be up to 1 mm. Shorter distances/widths/lengths may be desired, if the deformation is a stretching, perpendicular to a direction of stretching, where larger distances/widths/lengths, such as up to 5 mm or longer, may be provided in a direction of stretching, as the weakening of the material caused by larger slits is not as detrimental if directed along a direction of stretching.

The deformed first layer comprises a second plurality of through-going bores each having a cross section with a shortest distance of at least 2 μm. Naturally, these may also be larger, such as selected from the above minimum distance options. As mentioned, the bores may be desired larger, such as ranging from 5 μm to 50 μm or possibly up to 100 μm.

As will be described below, it is preferred that the walls of the bores in the first layer are rather liquid penetrable, such as of a porous material, as this facilitates both liquid and ion transport into and out of the material.

Also, the current collector comprises a plurality of channels or slits extending at least substantially in a plane of the current collector, or a main surface, preferably each channel/slit having a mean cross section with a shortest distance of at least 2 μm. Preferably, the channels/slits in the current collector intersect with through-going bores or slits in the first layer so as to be able to transport liquid from a first to a second bore. Again, the above alternative shortest distances may be selected between. Actually, the slits in the laminate may extend from an outer surface of the first layer and through the current collector.

Any number of first and second bores may be provided as may any number of channels. Preferably, a rather high concentration of such bores/channels is provided in order to achieve a sufficient liquid transport such as at least 10 bores per cm².

In one embodiment, the current collector comprises a porous material with a pore size defining the bores and channels. The current collector may, as is described below, comprise additionally a sheet-shaped element embedded in the porous material. The porous material may be the first electrode material if desired. Alternatively, the current collector may be formed by or comprise a woven or non-woven material, possibly comprising therein the porous material if desired.

Providing the porous material with or in the current collector increases the electrical connectivity to the other portions of the current collector.

In one embodiment, the electrode further comprises a second layer of a second electrode material, which may be the same as the first electrode material, provided at or on the second main surface, the second layer comprising a third plurality of through-going bores each having a cross section with a shortest distance of at least 2 μm, which again may be selected larger as described above. Thus, the slits of the deformed laminate may extend through the second layer also.

In one embodiment, the current collector comprises a laminate of:

a sheet of a third material, the sheet having a first and a second, usually opposed, main sheet surfaces,
a first layer of a first electrically conductive material provided on the first main sheet surface,
a second layer of a second electrically conductive material provided on the second main sheet surface,
where the current collector laminate comprises a plurality of portions each defining a direction, such as in a plane of the portion, being at an angle of at least 5 degrees to a central plane of the current collector laminate.

The first layer may be provided on the first main surface of the current collector before or after providing the slits and before or after deformation. Thus, the bores of the first layer may form part of a slit or at least some of the bores may open into a slit. Providing the layer after the deformation enables material of the first layer to travel into the slit and potentially make contact to material on the other side surface of the current collector.

The third material may be porous, non-porous or have a low porosity. The third material may or may not be electrically conducting. The third material preferably is flexible and light. Cheap materials are always preferred. Polymers may be used as the third material, as may polymers comprising electrically conducting materials, particles, fibres, flakes or the like. There are a large number of possible fibrous materials that can go into a compound that can be formed into a heterogeneous mesh. The materials include Carbon Fullerenes, GNP (Graphene Nano Platelets), amorphous coal particles, graphite, nano wires, natural fibers, polymers chains, metal wires etc. The main considerations are that the compound material should obtain sufficient tensile strength to be usable for the roll-to-roll manufacture approach while maintaining a desired low weight and thickness. The electric and thermal conductivity through the core material is advantageous as it reduces the required metallization of the core, which reduce cost and time to manufacture as well as both volume and weight. A suitable third material is a PET master batch with 15% Wt of graphene which may be used for producing BOPET films. Clearly lower or higher loadings of Wt % graphene is usable and the most advantageous choice will be a compromise of weight, volume, thermal conductivity, process time and BOM.

In this connection, a sheet is an element which is flat or has a low extent in one direction compared to the dimensions perpendicular to that direction.

If the third material has a sufficiently high electrical conductivity, the first and second layers may be left out.

The first and second electrically conductive materials may be the same or different materials. The first and second layers may be rather thin, such as 50 μm or less, such as 25 μm or less, such as 0.1-10 μm, such as 1-5 μm.

The portions may have any size, such as at least 0.05 μm², such as at least 0.5 μm², such as at least 5 μm², such as at least 10 μm², such as at least 20 μm², such as at least 50 μm², such as at least 100 μm², such as at least 250 μm². Each portion may have any desired shape and may extend from a main plane of the current collector or the laminate and away therefrom.

The angle may be at least 5°, such as at least 10°, such as at least 15°, such as at least 20°, such as at least 25°, such as at least 30° from a general plane of the laminate. The portions thus may extend up to 1-500 μm, such as 1-250 μm, such as 1-100 μm, such as 5-50 μm from the general plane.

Generally, it is desired to have an opening factor of approximately 1%-10%, such as 1%-5%, such as 5%-10%, through the current collector through stretching it in 3D. Much larger stretching is feasible and will lower the proportional weight of the current collectors in the electrodes and thus allow higher Wh/kg and Wh/L due to more charge holding anode and cathode materials. The number of slits per cm² will be approximately 20 but could be less or far more going into the thousands of openings.

20 slits per cm enables reasonable size piezoelectric needles. A normal contemporary dot matrix printer can print 735 characters per second each comprising 12 dots and deliver 90 dots per inch resolution. The speed and dots per inch resolution for a specialized printer may exceed a standard printer considerably as the printer heads can be fixed while the web is moved. This high speed can further be improved by the fact that the core of the current collector is thin.

When the portions extend in directions away from the central plane, the laminate assumes a 3D structure which has a number of advantages. This structure may be imposed in a number of manners described below, such as by punching holes in the laminate using e.g. needles or providing slits in the laminate and then pulling the laminate to arrive at the desired shape. These manners also have the advantages that the bores and channels may be formed in the same steps.

In a particular embodiment, the through-going slits are formed by a plurality of at least substantially parallel slits, such as in the laminate. These slits may be provided as through-going slits or may be provided as weakened portions, such as by scoring, cutting, ablation, perforating or the like, which may then be converted into openings, channels or bores by stretching or otherwise exerting a force to the laminate.

In that or another embodiment, a plurality of portions may be extending at an angle which is least 10 degrees from a mean plane of the current collector.

Naturally, the laminate may comprise additional layers, such as the well-known PEDOT material which provides a number of advantages as described below.

Polyethylenedioxythiophene polystyrene sulfonate is cheap and easy to form in an in-line process on the current collector web after holes have been made and metallization has been performed. Pedot coating is routinely performed in high volume products like photographic films and organic photovoltaic films and for various transparent antistatic coatings to prevent electrostatic discharges.

A second aspect of the invention relates to a battery laminate comprising a first electrode according to the first aspect of the invention, a second electrode and a separator layer provided between the first and second electrode layers.

Clearly, all aspects, embodiments and situations may be combined in any desired manner.

One of the electrodes, or the electrode material thereof, preferably is a material suitable as a battery anode. Usual anode materials may be Lithium titanium oxide (Li₄Ti₅O₁₂; LTO), Carbon-coated lithium titanium oxide (C-LTO), Silicon-graphite (Si—C) composites with different mass ratios, Silicon monoxide nanowire (SiOₓ-NW), Silicon monoxide nanowire-graphite (SiOₓ—C) composite, Tin oxide (SnO₂)/doped tin oxide, Graphite, Cu₂Sb, NiSb, ZnSb, MoSb, MnSb, InSb, AgSb, MgSb, TiSb, VSb, CrSb.

The other electrode, or the electrode material thereof, preferably is a material suitable as a battery cathode. Typical cathode materials are: Lithium cobalt oxide (LiCoO₂; LCO), Lithium nickel cobalt oxide (LiNi_{0.8}Co₀₁₅Al0.0₅O₂; NCA), Lithium manganese oxide (LiMn₂O₄; LMO), Lithium (excess) manganese oxide (Li₂MnO₃), Doped lithium manganese oxide (LiMn₂₋ₓMxO₄), Lithium manganese nickel oxide (LiMn_{1.5}Ni_{0.5}O₄; LMNO), Lithium manganese nickel cobalt oxide composite (Li₁₊ₓMnₓNi_{y}Co_{z}O₂), Iron Phosphate (FePO₄; FP), Aluminium phosphate (AlPO₄), Lithium cobalt phosphate (LiCoPO₄), Lithium iron phosphate (LiFePO₄; LFP), Doped lithium cobalt phosphate (LiCo₁₋ₓMxPO₄; M: Mn, Fe, Co, V, Gd, Mg), Ti-doped lithium manganese nickel oxide (LiMn₁₋ₓTiₓNi₅O₄; LTMNO), Iron disulfide (FeS₂), Titanium disulfide (TiS₂), Sodium manganese oxide (Na_{0.44}MnO₂; Na₂Mn₅O₁₀), Sodium manganese nickel oxide (NaMn₂₋ₓNiₓO₄), Doped sodium manganese nickel oxide (NaNi_{0.33}FeₓMn_{0.333}Mg_{y}SnzO₂), Sodium cobalt oxide (NaₓCoO₂), Sodium iron manganese oxide (Naₓ[Fe_{0.5}Mn_{0.5}]O₂), Sodium lithium nickel manganese oxide (Na_{0.85}Li_{0.17}Ni_{0.21}Mn_{0.64}O₂), Sodium iron phosphate (NaFePO₄-Olivine), Sodium cobalt mixed phosphates (Na₄Co₃(PO₄)₂P₂O₇), Sodium cobalt manganese nickel mixed phosphates (Na₄Co_{2.4}Mn_{0.3}Ni_{0.3}(PO₄)₂P₂O₇), Sodium iron mixed phosphates (Na₄Fe₃(PO₄)₂P₂O₇), and Sodium iron sulfate (NaFe(SO₄)₂; Eldfellite mineral).

Various oxide nanofibers can be synthesized. Notable examples includes ZnO, CuO, NiO, TiO₂, SiO₂, Co₃O₄, Al₂O₃, SnO₂, Fe₂O₃, LiCoO₂, BaTiO₃, LaMnO₃, NiFe₂O₄ and LiFePO₄.

Functional materials (molecules or nanoparticles) can be easily doped or incorporated into nanofibers by adding these materials or their precursors to the spinning solutions.

Electrospinning technique can also be used for fabricating nanofibers composed by non-oxide ceramics including carbide, boride, nitride, silicide and sulphide.

The electrospinning technique coupled with a thermal treatment approach, ZnS nanofibers can be prepared by sulfurizing the electrospun ZnO nanofibers (as a template) at 500° C. in an H₂S atmosphere.

The separator usually has the function of allowing ion transport through it but preventing direct, electrical contact between the anode layer and the cathode layer. Separators may be made of polymers, Kevlar, ceramics or the like. Preferably, the separator also allows some liquid transport through it. Usually, separators are porous and thus allow liquid transport.

Often, a liquid, such as an electrolyte, is provided in and around the separator to assist in the ion transport. This liquid also preferably is provided in the bores and the channels.

Preferably, also the second electrode may be an electrode according to the first aspect of the invention.

Naturally, the two electrodes may have different materials with different bore sizes and densities, but often the same liquid penetrability is desired in both electrodes.

The laminate may be straight, folded and/or rolled, such as before deformation.

A third aspect of the invention relates to a battery comprising a battery laminate according to the second aspect. A battery is a charge holding device usually comprising a chemistry which is configured to output a current. Naturally, a battery may comprise additional elements such as terminals each connected to an electrode, such as the current collector of the electrode, as well as a casing.

The terminals of a battery may be provided at two opposite ends thereof, such as is often seen in hard case batteries. Alternatively, the terminals may be provided at the same end if desired. In pouch type batteries, the terminals are often provided in the form of a cable connected to the pouch. An interesting casing is described in Applicant's below-mentioned application.

The casing thus may be a hard casing or a soft pouch. The casing may have additional components, such as vents and current interruption devices as well as different coatings and the like.

Often, casings have round cross sections in which the battery laminate may be provided as a roll. Pouches and prismatic housings may have therein folded laminates.

The battery laminate of the second aspect or the battery according to the third aspect may comprise a fluid provided between the current collector and the first and second electrode layers as well as in the slits. In this context, it is noted that polymers, such as PEDOT PSS is a fluid which may solidify to become a polymer, and which may be dissolved again. In general, polymers may be heated to become liquid.

A fourth aspect of the invention relates to a method of providing an electrode, such as for a battery, the method comprising:

providing a current collector having a first and a second main surfaces,
providing, at or on the first main surface, a first layer of a first electrically conductive material, and
providing, in the current collector, a plurality of weakened portions,
further comprising the step of deforming the current collector to form, at the weakened portions, slits with a length of at least 2 μm and width of at least 2 μm.

Thus, the current collector has a first and a second, typically opposite, main surfaces. The deformed current collector comprises a first plurality of through-going bores or slits each having a cross section preferably having a shortest distance of at least 2 μm, the slits of the current collector defining, between the first and second main surfaces, a plurality of channels extending at least substantially in a plane of the current collector, or a main surface, each slit or channel having a mean cross section with a shortest distance of at least 2 μm.

The first layer of the first electrode material, typically electrically conducting, preferably comprises a second plurality of through-going bores, often opening into the slits, each having a cross section with a shortest distance of at least 2 μm.

As described above, the current collector may generally be provided with a core element with a 3D structure, such as a mesh, woven, nonwoven, or a sheet which is shaped away from a plane structure, around and/or in which a porous material may be provided. On to this, or even in the same step, the first electrode material may be provided. Often, the core element, or the outer layers if provided, is/are made of a more or less solid or non-porous material. Preferably, this material may be the main path of current transport into the electrode material, especially if this material defines a path always defining a minimum width, such as 40 μm of the surface or first/second layers thereof so that a sufficiently capable current transport may be taken care of by this material and to also more remote portions thereof before handing over the current to the electrode material. The slits in the current collector may be oblong or half-moon shaped or triangular or having a cross or irregular serrated edges as function of the objects punching through and the punching process. Slits, bores, openings, holes are in essence all flow channels for respectively slurry solvents, electrolytes, ions and electrons. The tortuous routes for both the thermal and electric energy prolong the routes and will thus increase the resistance some, so on that count the orientation of slits may have an impact and also the openings required to establish liquid transportation are more than satisfied by 10% openings.

This current collector may then be embedded in a porous material facilitating the liquid transport. Preferably, the core material and any outer layers also has openings allowing liquid transport there through. This core element/laminate may then extend away from the electrode material and the porous material to become contactable from outside of the electrode material.

The first layer of the first electrode material may be provided in a number of manners. A legacy manner is lamination where the first electrode material is provided as one sheet-shaped material and the current collector as another sheet-shaped material which materials are then laminated to form a single element.

In a preferred embodiment, the step of providing the current collector comprises the steps of providing a laminate by:

providing a sheet of a third material, the sheet having a first and a second main sheet surface,
providing a first layer of a first electrically conductive material on the first and second main sheet surface,
providing a second layer of a second electrically conductive material on the first and second main sheet surface,
providing a first, second, third, fourth layer of charge holding material extending at least substantially in a plane of the current collector and through its openings.

The slits in the current collector may be provided in the third material before adding the first and/or second layers on the main sheet surfaces and before or after providing the first layer on the first main surface of the current collector.

The procession of processes can be altered such that the through-going bores par example is done after the first electrically conductive layer has been applied.

The first and second electric conductive material may be applied simultaneously by integrating particles of the first type of electrically conductive layer into the second electric conductive material. For the anode this would be nano copper particle integrated into PEDOT or the like. And for the cathode this would be aluminium particles into PEDOT.

As mentioned above, a number of manners exist of providing the slits in an element initially provided as a sheet-shaped laminate. Rollers with uneven surfaces may provide a 3D shape in the current collector and may additionally punch holes therein to form bores/slits and channels.

Preferably, the steps of providing the slits comprises the steps of providing weakened portions in the sheet, such as prior to the steps of providing the first and second layers, and a subsequent step of deforming the current collector. This subsequent step may act to open the sheet to form the bores and channels. Also, this step may act to break the first and second layers at the weakened portions, if these were provided subsequent to the weakening step.

Weakening may be the removal of a part of the material to reduce the effective thickness of the sheet at that position. Alternatively, a cut-through may be made, or a perforation may suffice so that the material is broken or opened during the subsequent step.

Such weakening may be a cutting, laser ablation, calendaring, or the like.

The subsequent step may be a step of pulling or extending the current collector laminate, such as in a direction at an angle to, such as at least substantially perpendicularly to, a direction of the weakened portions. In one situation, at least some weakened portions define elongate weakened portions which at least substantially extend in parallel directions to control that the current collector stretches primarily as elongation during the production process.

Naturally, different groups of weakened portions may be provided which define different directions so that the pulling/extension may be made in multiple directions, such as two directions perpendicular to each other. Also, individual portions may be deflected by running the laminate over a structured roll, one or more cogwheels or the like. Also, heat treatment or temperature gradients of the laminate may result in the desired deformation. Also, deformation may be obtained by bombardment by solid material, such as metal balls, deflecting or deforming elements.

This is one manner of obtaining a 3D shape of the current collector or a main current carrying portion thereof, so that this portion extends in different directions. The flaring out of this portion, often being a laminate, may be provided in a porous material so as to carry current to different portions of the porous material which may thus have a rather high variety of porosity ranging from 20% for very compacted areas to 100% in electrolyte channels, such as 50% or more, such as 60% or more, such as 70% or more, such as 80% or more, while still being able to receive a high current due to the large contact area between the porous material and the laminate/core material/outer layers. The porosity may then drop in the direction away from the 3D structure and toward an outer surface of the electrode, where the porosity may be lower than 30%, such as lower than 40%, such as in the interval of 30-35%.

As mentioned above, the method may comprise the further step of providing, at or on the second main surface, a second layer of a second electrode material, often electrically conducting, the second layer comprises a third plurality of through-going bores each having a cross section with a shortest distance of at least 2 μm. However, a distance in the range from 5 μm to 50 μm or possibly up to 100 μm may be preferred. Clearly, the above size considerations apply also in this aspect of the invention. The bores may be formed integrally with the slits or may open, at least for some bores, into the slits.

In a particularly interesting embodiment, the step of providing the first electrode layer comprises printing the first electrode layer of the first electrode material on to the first main surface. Printing has a number of advantages.

Firstly, the printing may be performed so that the bores are automatically generated simply by not printing any electrode material at that position. Punching the bores in existing electrode material is a possibility but it may have disadvantages.

It is preferred that the sides of the slits/bores are relatively open or porous so that liquids and ions may travel into the material from the bores.

Secondly, the printing may be performed by applying a plurality of layers, and each layer may be provided with different properties and actually even with different materials. This is described further below.

Printing may be performed by applying a slurry on the surface and in the pattern desired. A slurry may have particles or fibres of the desired electrode material as well as an adhesive binder and a liquid, often a solvent. Thus, different materials, different concentrations, different properties, different binders and the like may be selected from layer to layer.

A compacting may be desired of a printed layer. Not all layers may be desired compacted. Compacting may be obtained by providing the laminate between rollers. Compacting may affect the density of the layer and the openings of the bores, if provided by the printing.

An alternative to printing may be to provide the current collector in a mould comprising needles or the like for defining the bores. Adding the desired electrode material may then result in the desired structure of the electrode material with the bores. Bores in this context are not defined as bores where the material has been removed to create an opening but merely an opening in the electrode material or the current collector that is deliberately created. By this definition, bores can have almost any shape or form although we would often prefer relatively oblong bores and bores distributed evenly to optimise the flow of liquids, ions and electrons within the battery.

As described above, it may be desired that the material inside or close to the current collector has a large pore size and/or high porosity so that these pores may form the channels and bores in the current collector.

Another aspect of the invention relates to a method of providing a battery laminate, the method comprising:

providing a first electrode according to the first aspect of the invention or as provided by the method of the fourth aspect of the invention, where the electrode material is an anode material,
providing a second electrode according to the first aspect of the invention or as provided by the method of the fourth aspect of the invention, where the electrode material is a cathode material, and
providing a separator between the first and second electrodes.

As mentioned, this laminate may then be rolled, folded, stacked or the like and used in a battery.

In one embodiment, the method further comprises the steps of:

rolling and/or folding the battery laminate,
drying the rolled/folded/stacked laminate,
providing the dried laminate in a container and
adding a fluid to the laminate in the container.

During production of the laminate, liquid is often added or provided during the manufacture. This liquid is desired removed, as it is provided in the spaces where the electrolyte is desired. Thus, a liquid removal step, a drying, is performed. The bores and channels of the present laminate/electrode facilitate a swift liquid removal. Then, the electrolyte is subsequently added. Also, the addition of this electrolyte and its diffusion into the structure of the laminate is swift. Thus, a swifter production is achieved which does not require storing the laminate for extended periods of time while it dries or absorbs the electrolyte.

Yet another aspect of the invention relates to the above-described printing of the electrode material by providing the electrode material as a sequence of individual layers. Clearly, in this aspect, the through-going bores are not required even though they are preferred.

As described, this manner of providing the electrode material has the advantage that the properties of individual layers thereof may be controlled and be different. Another advantage is that, when bores are provided by not printing at that position in the layers, the wall of the bore will be formed by an open or porous material allowing easy access into the material of liquid and ions.

Firstly, the electrode layer preferably is electrically conductive. The material may, for example, have a high weight fraction of graphene and/or metal and/or carbon fullerenes.

Additionally, charging and discharging causes heat to be generated, so the electrode layer preferably also has thermally conductive properties. Clearly, if the electrode layer is porous, the electrical and thermal conduction properties are affected, so that the porosity and compaction of individual layers may be controlled and selected to achieve the desired properties at that particular layer in the electrode.

During production the built-in conductivity limit time duration and the inline length of the stage where the metal layer is added, which corresponds to faster web speed and thinner and thus lighter copper and aluminium layers on respectively the anode current collector and the aluminium current collector. Thinner and lighter current collectors for same electric and thermal conductivity translates to improved gravimetric and volumetric energy density while also improving the ability to build larger batteries with high thermal uniformity and low internal electric resistance. The latter improves the charge and discharge capabilities. Current collectors that are made from sheet materials that have very small porosity before being punched through with bores are preferred as they provide the best electric conductivity for volume and thus weight included the necessary electrolyte filling. Also, BOPET and other stretched polymers with CNT or graphene filling delivers outstanding strength for volume and in particular weight which reduce the overall weight and volume of the battery relatively to capacity. Non-limiting examples of the thermoplastics with or without carbon fullerenes reinforcement are polyacetal, polyolefin, polyacrylic, polycarbonate, polystyrene, polyester, polyamide, polyamideimide, polyarylate, polyarylsulfone, polyethersulfone, polyphenylene sulfide, polyvinyl chloride, polysulfone, polyimide, polyetherimide, polytetrafluoroethylene, polyetherketone, polyether etherketone, polyether ketone ketone, polybenzoxazole, polyphthalide, polyacetal, polyanhydride, polyvinyl ether, polyvinyl thioether, polyvinyl alcohol, polyvinyl ketone, polyvinyl halide, polyvinyl nitrile, polyvinyl ester, polysulfonate, polysulfide, polythioester, polysulfone, polysulfonamide, polyurea, and polyethylene terephthalate. Non-porous current collectors made porous by bores contain no electrolyte whatsoever while woven and non-woven embodiments of the innovation do, which leads to undesired weight and volume increase. The electrolyte contained in non-woven and woven current collectors is also adding cost as electrolytes are expensive.

Still, a current collector may be provided which may be a sheet or a 3D structure. For a 3D structure, non-woven versions comprising mixed fibrous materials (ceramics, natural fibers, polymer fibers or the like) may be used by e.g. mixing these as a paper like pulp with various oils or polymers for example. However, the above-described 3D structure of an electrically conducting laminate or layer is preferred. One differentiator between non-woven current collectors and current collectors that are made from a sheet, such as that described above which may comprise a non-permeable BOPET or similar stretched polymer core, is that the openings are forced during the production and can be located with precision with limited detrimental reduction of the electric conductivity as the incisions leave large parts of the conductive pathways undamaged.

The porosity of the current collector can be made randomly distributed by forcing the current collector toward a spiky layer/roller or by passing the current collector between cogwheel-like rollers that shape the current collector like crepe sheets potentially also punching holes therein. These two alternatives will generally produce perforations of random or semi-random character both in terms of positions and sizes of openings.

A more precise way of punching holes would be to use piezo electric dot matrix like actuators that create patterns of well-defined holes with desired sizes and orientation such that the current collectors become flexible in defined measures for defined areas. This may be to facilitate the desired 3D shape but may as well make the layer liquid permeable while allowing the electrode materials of both sides of the current collector to be connected through the current collector that thus becomes embedded inside the core of the electrode.

In general, it is preferred that the electrode materials of the two sides of the current collector are connected through the bore or slit, such as by extending through the bore/slit to provide a direct, physical connection through the bore. Then, the electrode material may form at least a portion of the inner surface of the bore.

The deposition of metal on all surfaces of the current collectors can be done by passing the current collector through a plasma treatment followed by a sputtering process in controlled argon atmosphere. Alternatively, electrodeposition may be used, such as for the metals or alloys preferred for the anode current collector such as copper, nickel or alloys of antimony such as NiSb, CuSb, ZnSb etc.

Subsequently, a PEDOT layer may be applied, such as in a protected atmosphere. Other electrically conductive glues are also available. One advantage of a PEDOT layer is that it creates a good electric and thermal connection between the current collector and the electrode.

The current collector, if provided flexible via the detailed bores, allows it to follow the movements of the electrode material and thus avoid that stress tears the current collector from the electrode material. Combined with PEDOT coating the contact between the current collector and the electrode materials is enhanced while the stresses caused by moving ions from the anode to the cathode and back during operation are both limited and better absorbed with reduced risk of delamination between the current collectors and the electrode materials which increase the charge and discharge capabilities.

The electrode material is preferably added from both sides using any number of different printing technologies and other materials deposition technologies.

Dip coating or spray coating or inkjet printing could apply the electrode foundation layer. Due to the many openings in the preferred 3D shaped current collector, the capillary forces will allow electrode material slurries to connect via the openings and after a short drying stage and calendaring stage there will be a uniform and solid foundation with electrode materials connecting through the opened bores and the current collector is effectively embedded as a 3D member of respectively the anode or cathode.

Different manners exist of printing layers on to e.g. a foundation layer, such as: screen printing, offset printing, gravure printing, relief printing, inkjet printing, laser printing, and intaglio printing. However, layers may also be provided by sputtering, such as possibly in oblique angles so as to ensure that essentially only the exposed surfaces is coated, or by plasma arch metal deposition, such as in oblique angles so as to ensure that essentially only the exposed surfaces are coated. The key element in oblique angle deposition is that the sputtered or plasma arch deposition layers tend to block liquid from passing through unless the surface prior to deposition is textured and the oblique angles ensures that depressed areas does not receive sputtered or plasma arch deposited layers. These inserted areas both serve to increase thermal and electric conductivity while also partake in the charge holding of both the anode and cathode.

Inserted between the application positions of different layers, drying stations and/or calendaring stations and/or laser processing stations, designed to ablate or laser fuse parts of the electrode coating, and/or embossing stations, designed to perform malleable processing involving heat and cogwheels that create desired 3D structures, may be provided.

All the print and deposition technologies may be operated in-line at high speed in roll-to-roll manufacture.

Any of the print or deposition processes can be used in any combination and in arbitrary succession so as to optimize the 3D structure of the electrodes to a desired design or property.

The materials composition for each print process can be defined independently of the other. Different printing or deposition processes offer different ranges of possible deposition layers and different circumstances. For example, sputtering and plasma arch deposition may deposit materials that have been heated excessively whilst other deposition technologies are low temperature processes involving liquids.

One objective of having several different printing, deposition and treatment stations in-line is to create a 3D controlled electrode with variable porosity, where some areas can be optimized for maximum thermal and electric conductivity whilst other areas may function as electrolyte channels, which in a battery may allow ions to flow past the separator between the anode and the cathode.

The electrolyte channels. slits or bores are preferably provided and kept open so that the side walls of the electrolyte channels are preferably made such that they are kept diffusive for electrolyte and ions. The bores/slits in the electrodes may be provided by the additive printing process when the individual layers are provided in register so that no printing is done at the bore/slit in all layers.

A calendaring, however, need not be additive as it is by nature compressive and will cause the electrode material to collapse inwards into the electrolyte channels. This inward collapsing can be calculated and any electrolyte channels provided will still be fully operational even if they are partly filled with debris from the collapsing.

In addition, a compression or calendaring will act to maintain a desired higher porosity of the material at or defining any bores in the electrode material. An even compression will compress the material away from bores/slits but due to the bores/slits, the material at the bores/slits will move slightly inwardly to reduce the size of the bore/slit, but as a result, the material at the bore/slit will maintain a higher porosity that the compressed material farther away from the bores/slits.

The effect of different porosity in each layer around the through-going bores or slits will be that there will be lateral layers with reduced porosity that connect to the through going bores/slits and create lateral flow channels that enhance liquid transportation that enhance the drying speed as well as the electrolyte filling speed while also creating faster ion transport in the finished electrode.

A special embodiment of the electrode printing process could involve relief printing where a relief form with large indentations creates a pattern of large electrolyte channels. The relief form is first filled with slurry, such as by the aid of a doctor blade, then married to the current collector that is pressed into the form and then married to an opposite relief form also filled with slurry and having similar indentations. The two relief form parts are preferably made from rubber or similar pliable materials such as silicon rubber or synthetic rubber and the material should be diffusion open for the slurry solvent but not the solid electrode materials particles. Each relief form will produce electrodes of an exact size directly usable for the production of cells of different sorts such as stacked pouch, jellyroll pouch, prismatic cells with stacked electrodes or electrodes in a jellyroll laminate and cylindrical cells with jellyroll laminate.

After a drying process that stabilizes the slurry around the current collector the double relief form is opened, and the electrode may be subjected to a calendaring process to collapse the sidewalls of the electrode material into narrower electrolyte channels.

In general, the porosity of battery electrodes may be desired to be 30% to 35%. However, the introduction of bores or electrolyte channels will create a more heterogeneous porosity and this may actually lead to a preferred different overall porosity where porosity variation within approximately 20% and 100% leads to a deeper and faster ion transport with better utilization of the electrode material. It has been known for years that there is an ever decreasing materials utilization with thicker electrodes, so having the inventive 3D structure allowing ions to engage deeply into the electrode layers may increase the wh/kg and Wh/L as well as the charge and discharge performance.

The precise distribution of the electrolyte channels can be guided by many objectives, one of which may be to ensure an evenly addressable electrode layer. Another objective may be to control the relative expansion and contraction of the anode and cathode, respectively, such that as little as possible exterior expansion and contraction of the entire battery occurs. Yet another objective may be to control the tensile stress of the electrode during expansion and contraction in order to preserve the structural integrity.

For electrolyte channels to function properly, they are preferably larger than the standard porosity routes inside the electrodes.

Any compression or calendaring will tend to reduce the thickness and thereby reduce the porosity. The resulting porosity of the electrolyte channels may be from near 100% to 50% and the size of the channels may range from 5 μm to 50 μm or possibly 100 μm with the definition of electrolyte channels being the area around openings where the porosity is larger than the general electrode porosity surrounding the electrolyte channels.

Print processes can be carried out with very wide webs and at high speed and it is customary to integrate several layers of print, which in terms of batteries means that the jellyroll can be assembled with the anode, including the current collector, the separator, and the cathode, including the current collector, and another separator in one process—which will generate a jellyroll that can be wound or folded to be used in either a pouch cell, a prismatic cell or a cylindrical cell.

Given that the size and shape of the electrodes may be predefined and controlled in the printing process, the laminate can be cut to shape no matter whether the shape is intended for stacked pouch cells, stacked prismatic cells, jelly roll pouch cells, jelly roll prismatic cells or jelly roll cylindrical cells.

In the following, preferred embodiments are described with reference to the drawing, wherein:

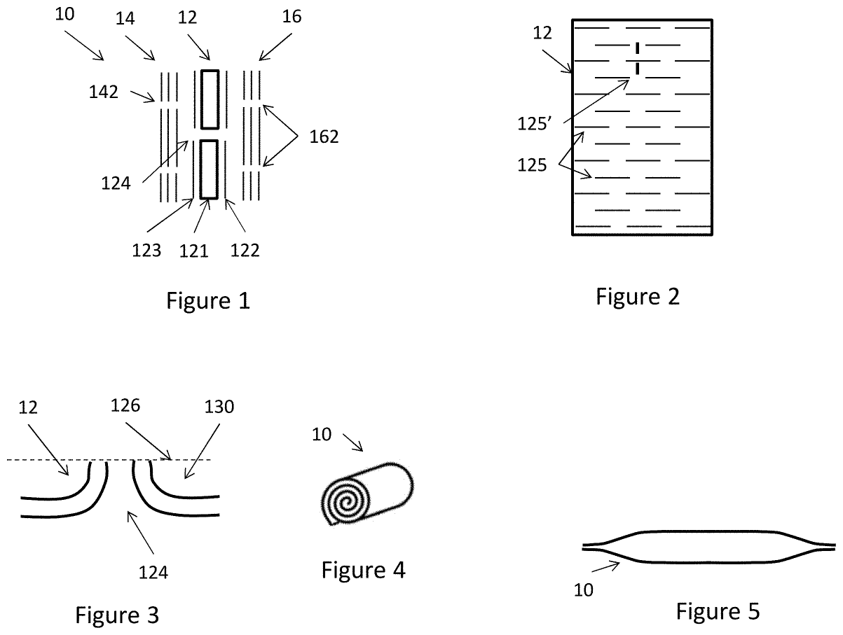

FIG. 1 illustrates a cross sectional and exploded view of an electrode according to the invention,

FIG. 2 illustrates a first manner of providing a 3D structure of a current collector,

FIG. 3 illustrates a second manner of providing a 3D structure of a current collector,

FIG. 4 illustrates a rolled battery laminate,

FIG. 5 illustrates a laminate with a varying thickness,

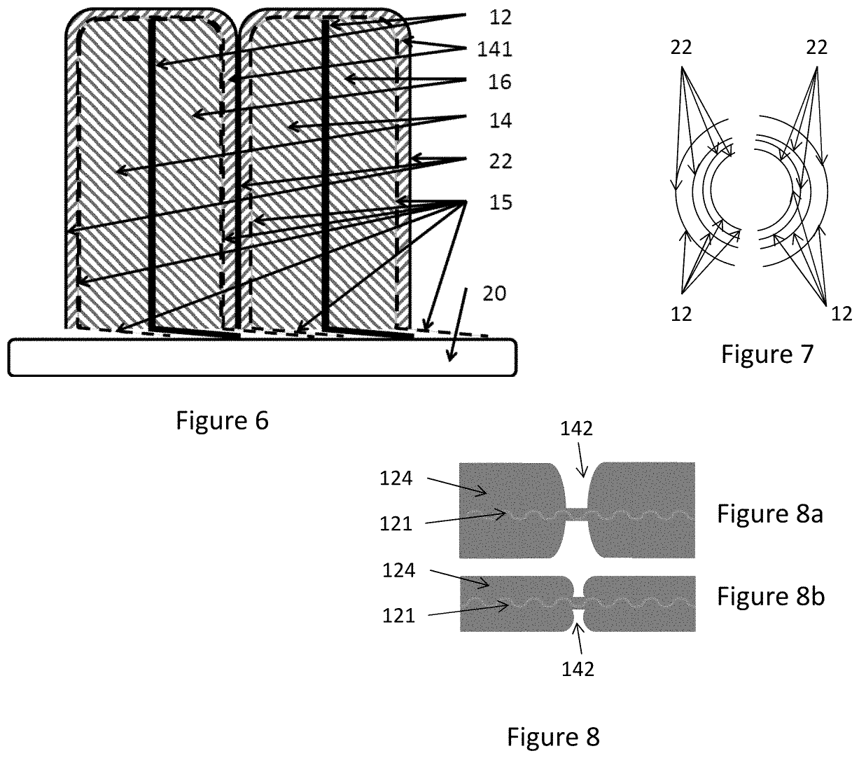

FIG. 6 illustrates a jelly roll laminate combed and connected to a cap and

FIG. 7 illustrate a jelly roll with both current collectors connected to a single cap.

FIG. 8 illustrate an electrode laminate before and after final calendaring.

In FIG. 1, an electrode laminate 10 is illustrated comprising a central current collector 12, a first electrode layer 14 and a second electrode layer 16. One electrode layer suffices, but two are preferred especially when combined (see below) with, but separated by, a separator from another electrode laminate to form a battery structure. A battery laminate is usually provided by two such electrode laminates where the electrode materials are selected suitably in the galvanic table. Often, aluminium is used as a cathode current collector and cupper is used as an anode current collector in batteries.

In the current collector 12, a through-going bore or slit 124 is seen. This bore/slit 124 has a size large enough to allow liquid or fluid transport there through. After deformation of the current collector, the slit 124 has a minimum size of 2 μm, but larger sizes will allow faster liquid transport. The size of the bore may be that of the bore when projected on to a plane perpendicular to a direction of the bore or the direction of liquid flowing through the bore. Naturally, a slit may be meandering, so that the size of the bore may vary along the bore.

This slit may be provided in a number of manners, some of which are described below. Less preferred manners are e.g. laser cutting or ablation, as this both removes material from the current collector and leaves the current collector completely flat as it was flat before the cutting. Below, however, is described a manner of converting a plane layer to a very useful 3D shaped element.

The current collectors are thus completely embedded in the electrode material and there is also electrode material in the openings of the current collector. The effect of electrode material connection through the current collectors is that the capillary liquid transport is improved and that the current collector and the electrode material connection becomes stronger and thus less likely to delaminate.

The two electrode layers also comprise through-going bores 142 and 162, respectively. These bores, as the slits, have dimensions allowing liquid or fluid transport there through.

Clearly, the laminate may have any length and any density and position, symmetrical or not, ordered or stochastic, of the slits 124 and bores 142/162.

In addition to the slits 124, the current collector comprises a channel-forming structure 130 (see FIG. 3) allowing liquid transport also generally along the direction or in the plane of the current collector. This may be obtained in a number of manners. In one situation, the current collector is or comprises a woven or nonwoven material allowing liquid transport both across the thickness thereof as well as in the plane thereof.

Other types of current collectors may be formed by initially non-permeable or non-porous layers, such as solid layers, in which holes/channels are made. Clearly, any material, porous/permeable or not, may be used now that the holes/channels are generated. It is noted that the liquid transport in or along the plane of the current collector may be obtained by making the current collector or the current collector material porous to the degree where liquid transport is facilitated. Alternatively, the current collector may be shaped or deformed to a degree where liquid transport is facilitated (see FIG. 3) along an outer surface thereof. This is described further below. The incisions seen in FIG. 3 may be varied in angles in order to create desired flexibility in different directions for the current collector.

The advantages of the slits 124 and bores 142 and 162 and the channels 130 is that they allow liquid transport through the layers and along/in the current collector so that the laminate may be dried swiftly and even if rolled into a roll as seen in FIG. 4 before drying. Any liquid or fluid remaining in the laminate may be allowed to escape via the channels and bores so that the laminate may be dried. Alternatively, the laminate may be added liquid or fluid also when rolled, as this liquid/fluid may find its way through the slits/bores and along the layers so that all or almost all spaces between the layers may be filled with liquid/fluid.

Most batteries today are slurry based in the sense that a liquid solution is used during the production process. Most of these liquids used for preparing battery slurries are toxic hazardous volatile organic compounds and create environmental and health hazardous conditions. For these reasons and because the fumes are explosive the slurry drying also involves a condensation and recycling process, which is the single most energy consuming process in battery production. The electrolyte is added to the rolled laminate in order to obtain the ion transport needed for proper battery functionality. The bores will vastly reduce the time required for the electrolyte to completely wet the laminate. Similarly, the formation process involving the creation of the SEI (Solid Electrolyte Interphase) can be performed significantly faster due to the freer flow of electrolyte and the ions within them because the ions can travel through channels with less tortuosity. The electrolytes used can be any commonly used electrolytes including liquid, polymeric and ceramic electrolytes.

As mentioned above, the current collector is provided so that liquid may more easily travel along the outer surface of the current collector and/or within the current collector.

The function of the channel(s) is to allow liquid travel, as well as ion travel, from a bore 162 through a slit 124 and further to a bore 142 or vice versa. Thus, the channels provide, with the bores, liquid and/or ion transport across the laminate.

Naturally, the manner of providing the slits 124 and the manner of obtaining the channels may be independent of each other, but the two properties may be achieved in the same process.

The channels may, as mentioned above, be defined by providing the current collector as a porous material. A porous material may be made of e.g. particles, fibres or the like allowing liquid transport in all or many directions.

Alternatively, the current collector may be made of any material, such as a non-porous material or a material with a too low porosity or pore size, where the current collector material is then provided with a 3D structure allowing the liquid transport. In FIG. 3, a structure is seen where a bore slit is formed by e.g. forcing a needle or other element through the current collector material which then both forms the bore 124 but is also forced outwardly (upwardly). Clearly, when the electrode layer 162 is provided at or on the surface of this current collector, the electrode layer will abut a surface 126 defined by the outwardly flaring portions around the slits 124. Then, liquid may travel in and/or along the current collector in the space of channel 130 defined between the current collector material and the electrode layer.

In FIG. 2, another manner of providing a 3D structure of a current collector material is seen. A number of more or less parallel cuts 125 are made in the current collector, which again may have any porosity, such as no porosity. When pulling the upper and lower surfaces (in FIG. 2) away from each other, the current collector will obtain a shape where openings or slits 124 are generated at the cuts 125 and where portions of the current collector will be flaring or directed upwardly and others downwardly. Naturally, the cuts 125 may be through going or extend only partly through the material. The pulling may break the weakened portions at the cuts. The portions between the cuts 125 then will obtain different angles to the plane of the current collector before pulling/deformation.

Clearly, the cuts 125 may be made only in the polymer layer 121, if this is a laminate as described below, such as prior to the providing of the conducting layers 122 and 123, as the layers 122 and 123 usually will be so thin, such as 1-10 μm, such as 2-5 μm, such as about 2 μm, that they will not be able to keep the cuts 125 closed but will break and thus form the bores 124. The scoring or cuts 125 may be provided by feeding the laminate (or the layer 121) between two rollers whereof at least one roller has a number of knives performing the desired cuts. Alternatively, the laminate (or the layer 121) may be fed through a needle printer, such as a piezo electrically driven needle printer, which is configured to perform the cuts desired in highly accurate repeatable patterns using needles that have the specific forms and orientation best adapted to create the desired porosity while preserving the optimum electric and thermal conductivity.

Alternatively, the layers 122/3 may be applied to the material 121 when stretched.

Alternatively, the laminate or sheet can be fed through two rollers along with random sharp, hard particles that punch through or weaken the sheet at random positions and perhaps also roughen the surface not punched through. The punched-through holes then again facilitate liquid transport and the roughened surface will define an outer surface engaged by the electrode and a space between the current collector surface and the electrode surface along which liquid may travel.

The pulling is preferably substantially along a direction at an angle to that of the cuts. Cuts may be provided with different angles (see cut 125′) to the direction of pulling, and pulling may be performed along multiple directions, such as along directions at an angle, such as perpendicular, to each other.

All these alternative processes are possible to adapt for high speed roll to roll processing as they are general for printing or embossing of webs passed through roll to roll processing and as such can be performed at great speeds.

Again, a current collector is formed having an outer surface defined by the outwardly flaring portions and where the electrode layers are brought to abut these surfaces and also connect through the punctured holes in the current collector. The current collector thus assumes a much thicker 3D shape than the actual current collector material, and the increased size gives rise to an internal porosity or channel forming allowing liquid transport not only perpendicular to the thickness or general plane of the current collector but also in a direction in the plane thereof. This internal structure additionally allows for a compressibility of the current collector which may be desired to take up any dimensional change of the electrode layer during charging/discharging.

The structured current collector may then be further altered before appending or attaching the electrode layer, the current collector may be slightly compressed to ensure that all outwardly directed portions thereof extend to a predetermined plane 126 to one or both sides, such as between parallel planes with a predetermined distance between them. Thus, when the outwardly directed portions are deformed or forced to adapt to a particular plane, these will form better electrical connections to the electrode material. Clearly, this deformation or altering will maintain at least part of the internal structure of the layer so that the liquid transport is possible.

The outer or main surface of the current collector thus is formed by the outwardly extending portions and any post processing these may be exposed to. This surface preferably is very open, so as to allow liquid transport into the current collector and between the two sides of electrode materials on both sides of the current collector and through it. Actually, the surface may be defined by a plurality of outwardly extending portions between which the liquid may flow.

In addition, the structural integrity of the connection between the metallic layer and the current collector core layer 121 can be enhanced by feeding the current collector core through a plasma process that nano roughens the surface prior to the deposition of the metallic layer. This will, combined with the physical deformation during the hole puncturing, increase the surface area of the current collector prior to the deposition of the anode metal or respectively the cathode metal layer. To further increase the connection between the current collector core and the added metal layer, the core itself can be made from a thermally and electrically conductive polymer such as polymers with a large proportion of graphene by wt %. Sputtering upon graphene filled polymer enhances the sputtered layers thermal, electric and mechanical attachment to the polymer core because the graphene flakes in the surface area upon the plasma treatment increase the surface area and embed the connection deeper into the core polymer than the polymer chains in the core material.

The outwardly extending portions may extend from a more central portion of the current collector. From this portion or such portions, which may be more plane without having to be completely plane, portions may extend in multiple directions so as to have portions extending toward both electrode layers if two are provided. The extending portions thus may be sheet-shaped or flat and may have any width and length.

The extending portions may be generated in any desired manner. Preferably, the extending portions extend from a central portion and are integral with it. The extending portions may be formed from an initial current collector element, such as a sheet, and caused extend from a plane of that portion or sheet. The above-mentioned drawing may be one manner of providing this extension or redirection. Another manner would be to permanently deform the extending portions, such as due to or during heating thereof.

When a portion extends from the central portion, the portion may leave an opening in the central portion, which opening then allows liquid flow through the current collector.

Naturally, if two electrode layers 14/16 are provided, the bore/slit forming structure may be performed from both sides of the current collector if such flaring portions are desired toward both electrode layers.

When the electrode material is provided at or on both sides of the layer or laminate, the electrode material may extend also through the bores/slits/channels of the layer or laminate. This may facilitate capillary liquid transportation such that drying once commenced will be completed to even dryness and similarly electrolyte filling also will be completed completely.

The current collector laminate may be manufactured in any desired manner, such as by depositing layers 122 and 123 on the layer 121 by lamination, sputtering, electro deposition or the like.

Clearly, the slits 124 and bores 142/162 need not be positioned as extensions of each other, as liquid or fluid may travel along the interface between the current collector and the anode/cathode, i.e. from a bore 162 to a slit 124 and further to a bore 142.

In FIG. 1, the electrode layers 14 and 16 are illustrated as laminates of a number of individual layers. The providing of the electrode layer as a laminate of a plurality of layers has a number of advantages.

One advantage is that the e.g. anode may now be provided as a laminate of layers with different properties and/or made by different process steps.

Such different properties can range from differences in porosity, difference in thermal conductivity, differences in electric conductivity, differences in charge holding properties and differences in particle size and shape, for example. The porosity differences in a 3D controlled electrode, such as an anode, can create electrolyte channels that increase the overall flow of e.g. Lithium ions while also creating denser areas where the thermal and/or electric conductivity is enhanced. The thermal and/or electric conductivity can also be enhanced by thin layers of metal alloys deposited by sputtering or plasma arch deposition and these layers may also comprise charge holding alloys, where Antimony based alloys are of particular interest and includes especially ZnSb, SnSb, CoSb and CuSb. Van der Waal forces are part of the forces that that hold the anode together and is impacted by the 3D shapes and sizes of the materials used. Long fibrous materials may hold the anode together with less usage of binder and may aid in the electric conductivity through larger anisotropic electric conductance.

As is described above, different layers may be provided with different materials, properties, porosity and the like. Different layers may be provided in different steps using different techniques if desired. In one situation, it is desired that the porosity of the electrode material decreases so that the porosity at the centre of the electrode material and at the current collector is high, so as to allow liquid transport. At the outer portions of the electrode material, the porosity may be adapted to other purposes such as a compromise between openness and the amount of material provided.

Preferably, however, the printing is performed so that the channels 162/142 are generated from the beginning. An alternative would be to provide the e.g. anode as a complete layer of the desired material and then provide the channels/bores by punching, laser ablation, cutting or the like. This providing of the channels/bores may break the integrity of the layer, as this layer preferably is quite thin. By providing the layer 14/16 by printing, no such working and thus no such risk is required.

In fact, another aspect of the invention relates to the above forming of an electrode as a number of, preferably at least substantially parallel, layers. Thus, the above advantages of the anode/cathode may be obtained. Naturally, in this aspect, the providing of the through-going bores 142/162 are only optional.

In FIG. 4, a wound or rolled-up laminate is seen. Clearly, an empty space will be seen at both the inner end of the laminate as well as at the outer end, when this cylindrical laminate is provided in a corresponding, cylindrical housing. It is desired to utilize all space in the housing. Thus, it is desired that the laminate is as thin as possible at least at the inner and outer ends, as this reduces the amount of space wasted.

On the other hand, the thickness of the laminate defines the loading capacity thereof, so a rather larger thickness is generally desired. In general, the thickness of the laminate scales more or less linearly with the loading capacity thereof, as the primary manner of reducing the thickness is the reduction of the thickness of the electrodes. Often, the current collector and the separator, which is usually provided between the anodes and cathodes of a battery, are not easily reduced in thickness.

A solution to this waste of space is seen in FIG. 5 where the outer ends of the laminate are made thinner so as to reduce the amount of space wasted while the majority of the length of the laminate has the desired thickness so that the desired loading capacity is obtained.

Naturally, a number of alternatives or additions may be used or utilized if desired. For example, as is known already, a PEDOT material or layer may be provided between the current collector, such as a woven/nonwoven or one or both layers 122/123, and the neighbouring anode/cathode. PEDOT materials are known for increasing electrical connectivity which is a sought-for advantage in batteries. Thus, the PEDOT material would form part of the current collector and thus also take part in forming the outer or main surfaces of the current collector.

A PEDOT layer also may reduce corrosion of the anode and cathode current collectors and thus increase the number of cycles the battery is able to obtain. PEDOT may fuse the electrode to the current collector and prevent separation from of the two, which both increase the Wh/kg, Wh/L and the charge and discharge characteristics of the battery. Further, the PEDOT layer may be viewed as part of the electrode as it can contain charge holding and electric conductive materials such as Carbon Fullerenes and in particular graphene for anodes and fluorographenes for cathodes.

In FIG. 6, a manner of providing a tab-less connection of an electrode with material layers 14 and 16 in a battery structure comprising another electrode with a current collector 22 and an anode/cathode material 141, separated by a separator 15. The left/lower side of the current collector 12 is connected to the cap 20. The outer electrode 22 may be contacted directly from the outer side thereof.

The ideal connection of a battery is along the entire length of the current collector because this in one and the same go provides the shortest thermal and electric pathways which consequently provides the least thermal and electric resistance. In a 18650 battery, 8 tabs are required to almost match the electric connection of a battery electrode in a coin cell. This impractical as the two tabs in an 18650 weigh 1% of the total weight and are costly to manufacture and connect. 8 tabs would increase the weight by 8% and cost about the same. Many problems in batteries arise from the tabs as the electric current from the current collector is routed through a thin tab that heat up and cause local early thermal damage to the battery electrodes nearby. Due to the resistance considerable Ohmic losses reduce the roundtrip efficiency of the batteries.

The embedded current collector connects electrically and thermally to the electrode along its entire area and extends out of the electrode as does the separator 15 that is inserted between the electrode materials 16/14 and 141. The connection to the cap 20 is made feasible by combing the extending separators and current collector to one side which create a spiral of current collector flanked by two spirals of separators one under underside of the current collector and one partly covering the current collector spiral. The separator extending on the underside of electrode material 14 ensures that there is no risk of short circuiting due to contact between the current collector 12 and the electrode material 141. Thus, the extent to which the separator 15 extends out of the laminate, i.e. compared to the electrode materials 16/14 and 141, so far that when bent to follow the underside of the laminate, it will cover the thickness of the material 141, thus preventing any contacting between the current collector 12 and the material 141 and the current collector 22. Now, the outwardly extending separator portions may be bent to one side, as may the outwardly extending current collector portions. As the separator portions are automatically positioned closer to the material 141, the separator portions will cover the material 141, so that the current collector portions 12 may extend as far as desired, and may all be contacted directly from below.

The exposed current collector 12 is exposed for connection to the cap by applying a conductive material. The conductive material not shown in the drawing can be chosen among several options such as low melting point solders such as SnSb alloys or conductive glues such as PEDOT. The solder can be pre coated upon the cap and activated by applying heat that liquefy the solder without harming the separators or the current collector or the cap. For lower solder fuse temperature a solder paste that is essentially powder metal solder suspended in a thick flux medium. The solder paste acts as a temporary adhesive, holding the components in place until the soldering process melts the solder and fuses the parts together. By use of flux the solder temperature can be decreased. Solder paste can be printed onto the cap or can be applied through holes in the cap not shown in the drawing. Connecting with PEDOT or other electrically conductive glues widely used in the electronics industry for SMD component can applied in the same ways as the solder paste only the glues usually are two component where the polymerization is induced by applying heat or UV radiation. For applying either UV or heat the holes in the cap are useful. Alternatively, the cap can be made from a UV transmissive material such as polymer or ceramics. As the cap function as a part of the thermal pathway transparent versions should be chosen among materials with good thermal conductivity such as par example diamond, diamond like carbon, Silicon Carbide. For electric conductivity the cap should be connected to a conductive material from where the conduction of current to the battery terminals. Alternatively, the cap can be made from opaque materials such as conductive materials as for instance metals like steel, aluminum, copper, titanium, nickel, lithium, silicium or alloys hereof. Clear many other metals could be used and alloys hereof but the sort after properties are lightweight easy solder and glue connection and low cost, so alloys involving aluminium are probably the go to solution. The issue with soldering on especially aluminum can be sorted by coating the metal cap design with a layer of copper or nickel which is a well-established practice in the electronics industry.

The FIG. 6 shows a connection of a battery with a U shaped laminate (Applicant's co-pending application PCT/EP2020/064868) but is equally useful for a design where the anode and cathode current collectors are folded and connected in each end of a jelly roll. And similarly if the laser shrinking is performed in register with the subsequent winding the anode and the cathode current collectors can connect to different areas of the same cap. Cutting a laminate with separators, anodes and cathodes will leave the anode and cathode equally protruding inside the separators, which will make connection challenging. The challenge can however be resolved by heat shrinking the cathode current collector or the anode current collector. For this process to function the heat shrink temperature has to be applied separately to either the anode current collector or the cathode current collector. This can be achieved by selecting the separator from materials that withstand heat such as non-woven aramid fiber separators combined with a focused laser heating that created the desired shrinking temperature in a specific depth. Additional the laser can be operated from the side where the current collector to be shrunk is closest and additionally the laser shrinking can be performed when the laminate is on a cooled roller and additionally the wave length of the laser can be tuned to be absorbed to a greater extend by either the anode current collector or the cathode current collector.

Two areas respectively for the anode and the cathode current collector connection will suffice but if so desired a multitude of connecting areas for both the anode current collector and the cathode current collector can be provided.

The flexibility of the current collector, which was introduced with the openings created for liquid flow through the current collector, ensures that when the ends of the separators and current collectors are combed to one side they will fold over each other and expose a spiral of current collector overlaying a layer of separator. The combing allows the addition of PEDOT or similar electric conductive glue that connect the entire length of the current collector to a conductive cap, which ensure as short as possible thermal and electric pathways.

In FIG. 7, a manner of providing a tab-less connection of the electrodes 16/14 and of another electrode formed by the material 141 and the current collector 22 (see FIG. 6) to the cap 20 via the current collector 12 of the electrode 16/14 and current collector 22 of the electrode material 141. FIG. 6 illustrates a connection of a battery with a U-shaped jelly roll laminate. For normal industry standard laminates, the solution can be cap systems in both ends. However, it is advantageous for many cells to keep the connection of both the anode and the cathode current collectors on the same side which is seen in FIG. 7.

A standard battery laminate comprises a separator, an anode, a separator, and a cathode. For the preferred roll to roll production it is advantageous to produce the complete laminate prior to winding it up and even more preferably before the laminate is not completely dried. This requires the general laminate to be separated into laminates for specific battery sizes such as coin cells, stacked pouch, stacked prismatic, jelly roll pouch, jelly roll prismatic and jelly roll cylindrical. This can be done one by one, before they are stacked to form the final laminate, but it is very advantageous to do the entire process at web level by stacking the laminate first, before separating into laminates destined for each battery (coin cells, stacked pouch, stacked prismatic, jelly roll pouch, jelly roll prismatic and jelly roll cylindrical).

After the separation into single-battery laminates, it is desired that both current collectors are engageable from the same end of the laminate. In fact, the separator and both current collectors may extend outside of the electrode area to the same degree, which prevents the simplified combing process illustrated in FIG. 6 because both the anode and a cathode spiral will be addressable.

Compared to FIG. 6, removal of part of the first and second current collectors is desired to allow access to one but not the other.

In FIG. 7, the battery laminate is a roll. Thus, a portion of the current collector 22 and portions of the current collector 12 have been removed at portions of the laminate being in the upper half of the roll. Clearly, contacting at either end would be possible if portions of the current collector 12 were instead removed in portions at the lower half.

Now, the current collectors may, as is seen in FIG. 6, be bent outwardly. The separators preferably extend outwardly between the outwardly extending portions of current collectors 12 and 22 so as to, as in relation to FIG. 6, ensure no short circuiting between one electrode and the current collector of the other electrode. In this manner, the upper (in the drawing) surface of the battery roll (end) may be used for contacting to one electrode and the other to the other electrode.

Clearly, multiple portions of the current collector 12 may extend outwardly at different circumferential portions, as may multiple portions of the current collector 22.

Also, the bending may be easier if the current collection portions to be bent do not extend a large portion of the circumference of a winding of the roll. Thus, the outwardly extending portions of e.g. current collector 12 may be divided into several narrower portions.

Preferably, a portion of the separator is removed, cut or severed between neighbouring portions of the extending portions of current collectors 12 and 22, so that the separator may be bent in the same manner as the current collectors.

Naturally, the portions of the current collectors may be removed prior to lamination. Alternatively, as will be described below, the removal may take place on the laminated structure.

Naturally the combing can also be inwards or even inwards for a part and outwards for another part of the jelly roll.

If the laminate is not rolled but folded, the same technology may be used so that the current collectors extend away from the laminate at one side of a folded laminate, but the current collector 12 is removed at one or more first portions along that side and the current collector is removed at other, second positions along the side. Then, the current collector at the first portions may be bent to one side, again with the separator preventing short circuiting, and the current collector at the second portions may be the same. Connection then will be very simple.

Is it noted that by the present methods, each winding or layer of the laminate may be connected—even at multiple positions if desired.

One way to connect could be to design a cap with holes in register with respectively the anode spiral and the cathode spiral in a first not electric conductive part of the cap an then apply solder or glue through the holes in the cap and perform the soldering or glue process. Alternatively, the cap can have multiple holes and the solder paste or glue paste can be applied with a vision control robotics process. The latter process entails the advantage of not requiring the design to be in register and to being able to utilize the powers of vision control processing to our advantage. In the two first mentioned principles the precise character of the separator is not important unless the temperature in par example the solder process exceeds the thermal limits for the separator and thus induce risk of shrinking or other physical deformation processes that compromise the separation between the electrodes and or the current collectors from the electrodes. Choosing the separators from among separators that are ceramic, are ceramic coated or are made from polymers with high heat resistance, as par example Aramid fibres, can mitigate this thermal compromising risk.

For the following laser shrinking principle, the combing process may be preceded by a vision controlled laser shrinking procedure where the laser track the areas of the laminate where the protruding anode and cathode current collectors should be shrunk to avoid the risk of them being exposed in the spirals/roll on particular areas. When the vision control system has receded respectively the anode current collector and the cathode current collector there will be a pattern of connectable anode current collectors and cathode current collectors as seen in FIG. 7.

This allows the same cap mount principles as explained in relation to FIG. 6. Laser optics move fast and vision control is highly accurate so the process is highly accurate, fast, repeatable and cost effective in high volume production environments.

Alternatively to handling the preparation for current collector to cap connection post roll to roll the process can also be performed in roll to roll domain by use of a system where heat resistant separators are used in conjunction with lasers focused to heat up and thus perform shrinking in a predetermined range of depths. The lasers can be placed in rows and be configured to shrink portions which are in register, such that the battery when readied for connection between current collector and cap obtains the correct positioning of the current collectors even for wound jelly rolls.

In order to protect the protruding current collector, which is not to be shrunk, the laser treatment can take place upon a cooled roller that limit the heating. Further, the wavelength of the laser can be tuned to be especially heating of one or more of the compound materials in the respective anode or cathode current collector, such that the light energy impinging upon the to-be-shrunk current collector will have a bigger effect upon it than upon the other current collector. The vision control system can further control the x,y laser focussing such that is mostly avoided to direct laser energy towards the current collector not to be shrunk as the upper current collector constantly shadows the current collector not to be shrunk.

Alternatives such as cutting with knife or handling the laser shrinking without the laminate have been formed are also conceivable. For example, each laminate layer would be required to be handled separately and then adjourned into the desired laminates.

The combing can be to either side and there are advantages for both sides. In the direction inwards to the centre of a jellyroll the spiral becomes smaller than the perimeter of the wound jelly roll, which is advantageous because there are no issues with the part of the combed materials jutting out and the cap can be produced in slightly smaller size and still connect all spirals. In the outward direction the combing action is naturally performed during the winding.

It should be mentioned that the combing will be facilitated when the current collectors are flexible, such as based on the laminate of FIG. 1.

One of the major advantages of the present connection manner is, beside the fact that the multiple connections to the roll will reduce resistive heat generation and associated losses, is that batteries connected in this way also achieves considerably better round trip efficiency through lower Ohmic resistance and far better charge and discharge rates as well as a much longer projected lifetime. Single or few tab connected standard batteries are plagued with local fast aging due to heat generation concentration due to heterogeneous electric field lines concentration that expend the part of the battery where there initially are the best electric conductivity. The tab-less mode uses the entire electrode laminate more evenly as a consequence the of more evenly distributed electric connectivity.

Another major advantage is that not only is less heat generated in response to Ohmic losses this heat generation is much lowered during high charge and discharge rates and moreover the heat is better ported out of the battery because the caps are feasible to connect thermally over a large area to the casing.

A last major advantage is the combing increase the space available for the jelly roll through increasing the length in both end relative to standard batteries where the void over and below the jelly roll is used for extensions of the separators and current collectors. This detail increases the Wh/kg and Wh/L and the Wh/$ by allowing proportionally more space and weight for the jelly roll.

When the battery is winded and connected to one or more caps it can be inserted into either a centrifugal dryer or a vacuum drying oven. The completion of the stack or jellyroll greatly reduce the volume of the laminates to be dried and thus the space consumption inside the vacuum oven and the energy consumption because the energy consumption scale with volume of the vacuum oven and the permeability of the laminate. Pre-drying with a centrifugal dryer greatly reduces the amount of solvent required to be removed and thus the time, volume and energy expenditure of the vacuum drying ovens. The centrifugal drying step can be further enhanced through forcing inert gas such as argon through the laminate. The centrifugal and gas forcing drying can be combined and reduce the drying time and temperature which limits the corrosion damaging of the electrode materials as the remaining vacuum oven drying can be performed faster and at lower. It should be noted that anodes frequently use demineralised water as solvent, which would lead to damaging corrosion of the cathode material. However, the anodes are generally less sensitive to heating so aggressive laser drying could dry out the anodes completely prior to the assembly of the laminate.

In FIG. 8a an electrode is shown before final calendaring and in 8b after the calendaring. Embossing electrolyte channels after calendaring defies the purpose because the embossing cause a steep local decrease in the porosity in and around the sidewalls of the electrolyte channels which naturally renders the embossed electrolyte channels completely useless waste of space and materials. However, provided the electrolyte channels are made oversize before the electrode is entering the final calendaring process the final electrolyte channels will be diffusion open for both slurry solvent drying and electrolyte infusion. As the electrode material implode into the oversize flow channels seen in FIG. 8a the gradient of porosity increases towards the centre of the flow channels. Relatively to par example laser ablation this collapsing electrode layer approach removes no materials and there is no risk of dust contamination or heat damage of the electrode materials. Further the process can be completed well in time before the drying out of the electrode material solvent begins.

Naturally, the laminate may alternatively be folded so as to fit into pouch type batteries or prismatic type batteries.

1.-18. (canceled)

19. An electrode, such as for a battery, the electrode comprising:
a current collector having a first and a second main surfaces,
a first layer of a first electrically conductive material provided at or on the first main surface, and
where the current collector comprises a plurality of slits, having a length of at least 2 μm, the laminate being deformed to provide the slits with a width of at least 2 μm.

20. The electrode according to claim 19, further comprising a second layer of a second electrode material provided at or on the second main surface, the slits of the deformed laminate extending through the second layer.

21. The electrode according to claim 19, wherein the deformed current collector defines a plurality of portions each defining a direction being at an angle of at least 5 degrees to a central plane of the current collector.

22. The electrode according to claim 19, wherein the slits comprise a plurality of at least substantially parallel slits.

23. The electrode according to claim 19, which has a plurality of portions extending at an angle which is least 10 degrees from a mean plane of the current collector.

24. A battery laminate comprising a first electrode according to claim 19, a second electrode and a separator layer provided between the first and second electrodes.

25. The battery laminate according to claim 24, wherein the second electrode is an electrode.

26. The battery comprising a battery laminate according to claim 24.

27. The battery laminate according to claim 24, further comprising a fluid provided between the current collector and the first and second electrode layers as well as in the slits.

28. A method of providing an electrode the method comprising:
providing a current collector having a first and a second main surfaces, where:
at or on the first main surface, a first layer of a first electrically conductive material is provided,
providing, in the current collector, a plurality of weakened portions,
further comprising the step of deforming the current collector to form, at the weakened portions, slits with a length of at least 2 μm and width of at least 2 μm.

29. The method according to claim 28, wherein the deformation causes the current collector to define a plurality of portions each defining a direction being at an angle of at least 5 degrees to a central plane of the current collector.

30. The method according to claim 28, further comprising the step of providing, at or on the second main surface, a second layer of a second electrode material, the second layer comprises a third plurality of through-going bores each having a cross section with a shortest distance of at least 2 μm.

31. The method according to claim 28, wherein the step of providing the slits comprises providing a plurality of at least substantially parallel slits.

32. The method according to claims 28, wherein the deformation step comprises a step of stretching the current collector.

33. The method according to claim 31, wherein the deformation step comprises a step of stretching the current collector and
wherein the stretching is along a direction at an angle to a direction of the slits.

34. The method of providing a battery laminate, the method comprising:
providing a first electrode according to claim 28, where the electrode material is an anode material,
providing a second electrode, where the electrode material is a cathode material, and
providing a separator between the first and second electrodes.

35. The method of providing a battery laminate, the method comprising:
providing a first electrode according to claim 19, where the electrode material is an anode material,
providing a second electrode, where the electrode material is a cathode material, and
providing a separator between the first and second electrodes.

36. The method according to claim 34, further comprising the steps of:
rolling and/or folding the battery laminate,
drying the rolled/folded laminate,
providing the dried laminate in a container and
adding a fluid to the laminate in the container.

37. A battery according to claim 25, further comprising a fluid provided between the current collector and the first and second electrode layers as well as in the slits.

38. A method according to claim 35, further comprising the steps of:
rolling and/or folding the battery laminate,
drying the rolled/folded laminate,
providing the dried laminate in a container and
adding a fluid to the laminate in the container.
